(19) United States
(12) Patent Application Publication
(10) Pub. No.: US 2020/0155879 A1
(43) Pub. Date: May 21, 2020

(54) Guiding Type Anti-Falling Harness Unit

(71) Applicant: Tian Hsing Chang, Taoyuan City (TW)

(72) Inventor: Tian Hsing Chang, Taoyuan City (TW)

(21) Appl. No.: 16/527,024

(22) Filed: Jul. 31, 2019

(30) Foreign Application Priority Data
Nov. 21, 2018 (TW) 107215806

(51) Int. Cl. A62B 35/00

(52) U.S. Cl. CPC A62B 35/0037; A62B 35/0018

(57) ABSTRACT

A guiding type anti-falling harness unit includes a safety wear comprising a strap unit on the back thereof for a support member and a lifting ring to mount. The support member has a first slot and a second slot for the strap unit to pass through so as to define a securing region between the strap unit and the outer side of the support member. A bushing is arranged in the securing region and has a channel provided transversely across the securing region. The bushing has a slideway to allow the bushing to correspondingly move up and down along the strap unit within the securing region and without escaping from the left or right side of the securing region easily. The channel is adaptable for a latch of a connecting device to couple with. Accordingly, the harness unit allows the user to quickly latch the latch at the securing region directly without pulling the strap unit, which greatly enhances the adaption in mounting and dismounting of the connecting device.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field Of Invention

The present invention provides an anti-falling harness unit that is capable of guiding the mounting of the connecting device, so as to enhance the adaption in mounting and dismounting of the anti-falling harness unit for the users.

### Description of Related Arts

Anti-falling harness unit is a necessary apparatus to ensure personal security in various working circumstances, such as rock climbing, mountain climbing, building construction, offshore operation, oil extraction, mining, and etc.

FIG. 1 shows a conventional anti-falling harness unit, which includes:

a safety wear 91, adapted for being worn by a personnel, wherein the safety wear 91 includes a strapstrap unit 910 on its back constructed by a first strap 911 and a second strap 912 arranged in a cross manner;

a support member 92, having a first slot 921, a second slot 922 and a third slot 923, wherein the first slot 921 is provided in an upper portion thereof and each of the second and third slots 922 and 923 has a pair of parallel grooves formed inclinedly below the first slot 921, so as to allow the first strap 911 to pass through the first slot 921 and the second slot 922 and allow the second strap 912 to pass through the first slot 921 and the third slot 923 in order to form a securing region 93 therebetween, wherein the height of the securing region 93 is defined between the first slot 921 and the second slot 922;

a lifting ring 94, having a strap groove 941 that matches with the first slot 921 so as for the strap unit 11 to pass through and a lifting hole 942 provided above the strap groove 941 in order for being hung on a main hanging spot (such as a beam or column of a building, a mounting ring, and etc.);

a connecting device 95, including a frame 951 and a lockable and detachable latch 952 coupled with the frame 951.

The frame 951, between two ends thereof, provides and defines a hanging space 953 having an opening 954. The securing region 93 is adapted to match with and position within the opening 954. The lockable and detachable latch 952, passing through the securing region 93, is mounted between two ends of the frame 951 in an openable and closable manner, such that the connecting device 95 is able to be coupled with two anti-falling devices 961 and 962, wherein the first anti-falling device 961 is firstly mounted on a first auxiliary hanging point, wherein when the user moves the first anti-falling device 961 to enable a maximum range for the first anti-falling device 961, the user is able to mount the second anti-falling device 962 onto a nearby second auxiliary hanging point. Then, the first anti-falling device 961 is detached from the first auxiliary hanging point. In this manner, the user is able to orderly and alternately operate the mounting and detaching of the first anti-falling device 961 and the second anti-falling device 962 onto various auxiliary hanging points of a structure for the user to move transversely above the ground. Therefore, even when the user accidentally falls, the user will be hung and supported in the air by means of the first anti-falling device 961 or the anti-falling device 962, equipping with the lifting ring 94, to wait for rescue. It is worth specifically mentioning that the connecting device 95 may also utilize the prior technology of U.S. Pat. No. 9,174,073 B2, entitled “Energy Absorber Assembly and Components Thereof”.

In order to reduce the laborious of the person who carries the first anti-falling device 961 and the second anti-falling device 962 for long period of time, the lockable and detachable latch 952 is usually detached from the securing region 93 when the person has not entered the working environment above the ground. Nevertheless, before the person enters any working environment above the ground and working at height, the lockable and detachable latch 952 must be securely mounted at the securing region 93. Unfortunately, some users have complained that it is troublesome and time consuming to clutch the lockable and detachable latch 952 at the securing region 93. The reason is that the lifting ring 94 will naturally drop and lean against the outer side of the strap unit 910, which hinders the user to pull the strap unit 910 and open the securing region 93. Also, the strap unit 910 can easily be distorted, which requires the user to pull it very hard in order to increase the distance between it and the support member 92 to allow the lockable and detachable latch 952 to enter in or remove from the securing region 93 without interference. Therefore, the conventional technology is not convenient in mounting and dismounting the connecting device 95, such that improvements therefor are necessary.

Moreover, when the user walks or accidentally falls, the connecting device 95 bears stress, which renders stress concentration, including having the lockable and detachable latch 952 constantly colliding with the support member 92 or constantly rubbing the strap unit 910, which can adversely influence the durability and security of the overall structure of the apparatus.

To deal with the above drawbacks of the prior art, the inventor of the present invention has devoted to research and developed the present invention that improves these conventional drawbacks.

### SUMMARY OF THE PRESENT INVENTION

The present invention mainly provides a guiding type anti-falling harness unit, which comprises:

a safety wear, adapted for being worn by a personnel, wherein the safety wear comprises a strap unit on a back thereof for mounting one or more lifting rings;

a support member, having an inner side adapted for leaning against the user and an outer side opposite to the inner side, wherein the support member has a first slot and a second slot for the strap unit to pass through, so as to define a securing region between the strap unit and the outer side of the support member;

a connecting device comprising a latch; and

a bushing arranged in the securing region to define and provide a channel transversely across the securing region, wherein the bushing has a slideway to allow the bushing to correspondingly move up and down along the strap unit within the securing region and without escaping from a left side nor a right side of the securing region informally, wherein the channel is adaptable for the latch of the connecting device to couple with the bushing.

Accordingly, the present invention allows the latch to quickly latch at the securing region directly without pulling the strap unit, which greatly enhances the adaption in mounting or dismounting of the connecting device. Besides, when the connecting device bears stresses, the bushing can mediate and buffer the stress bearing among the latch, the support member, and the strap unit, which makes the overall structure and arrangement of the hardness unit more durable and secure.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a PRIOR ART.

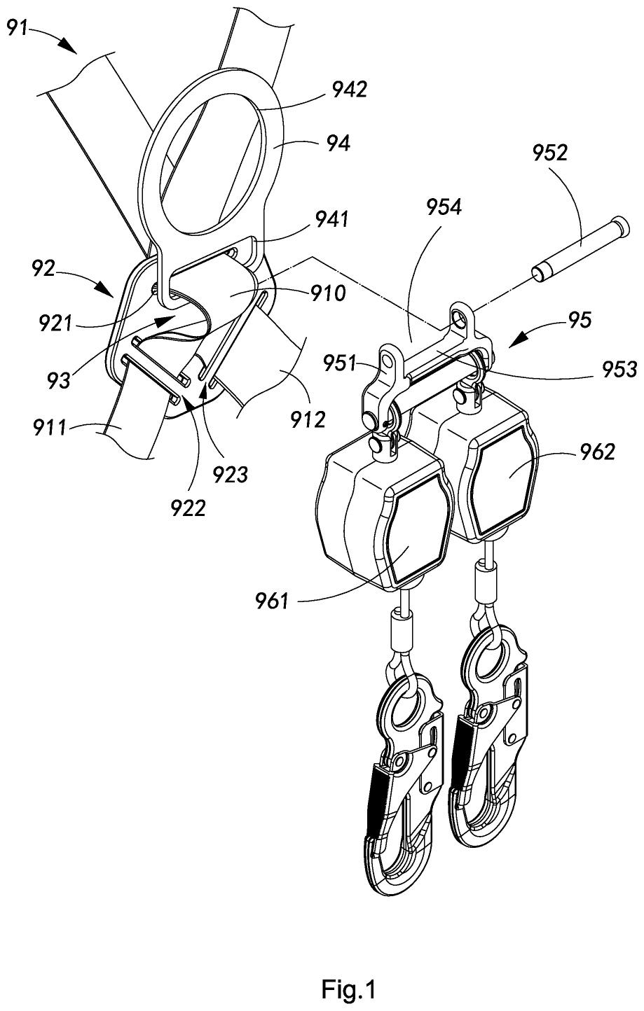

FIG. 2 is an exploded view of a preferred embodiment of the present invention.

FIG. 3 is a sectional view of a bushing of the above preferred embodiment of the present invention.

FIG. 4 is a perspective view of the above preferred embodiment of the present invention, illustrating the bushing mounted at the securing region.

FIG. 5 is a sectional view of FIG. 4 along the A-A direction thereof.

FIG. 6 is a rear view of the above preferred embodiment of the present invention, illustrating a connecting device being mounted.

FIG. 7 is a sectional view of FIG. 6 along the B-B direction thereof

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

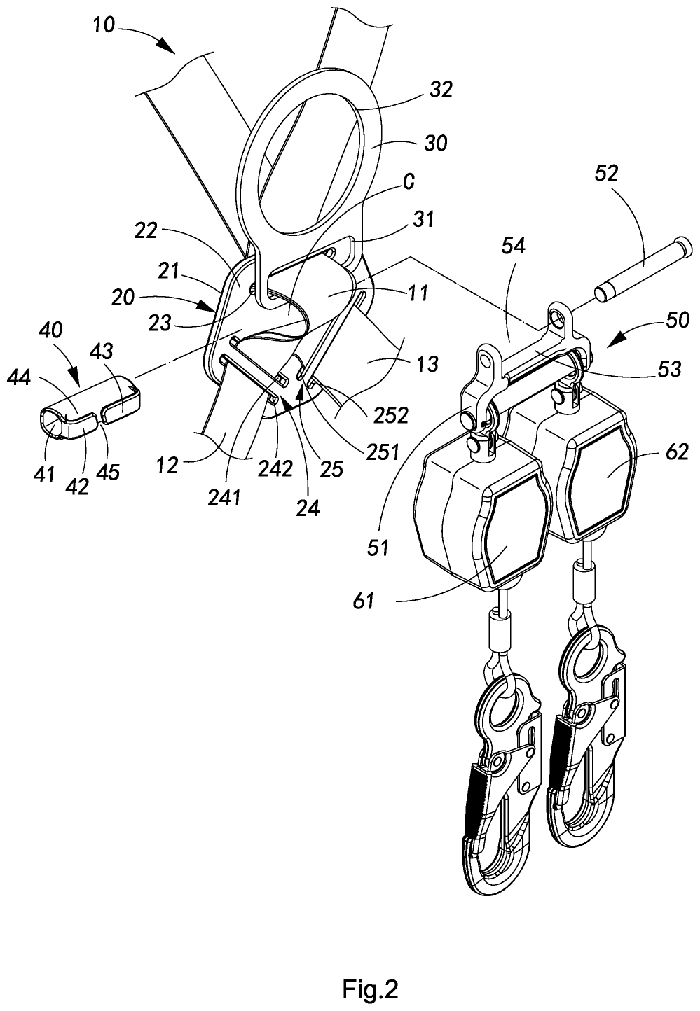

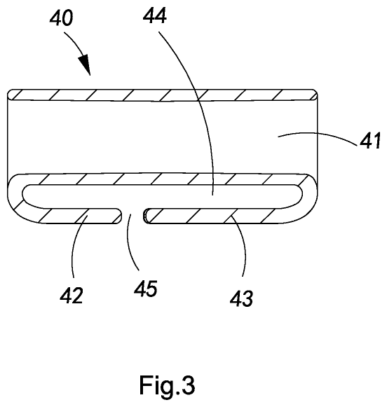

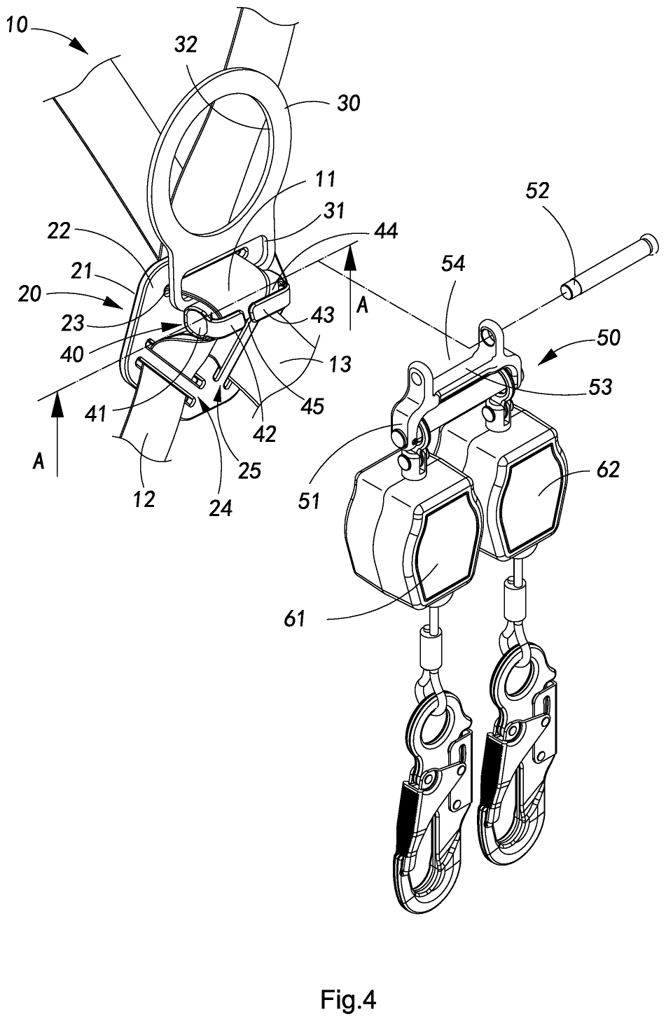

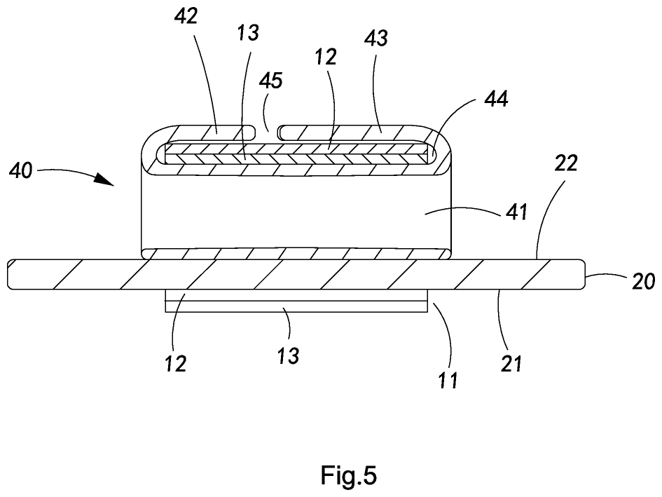

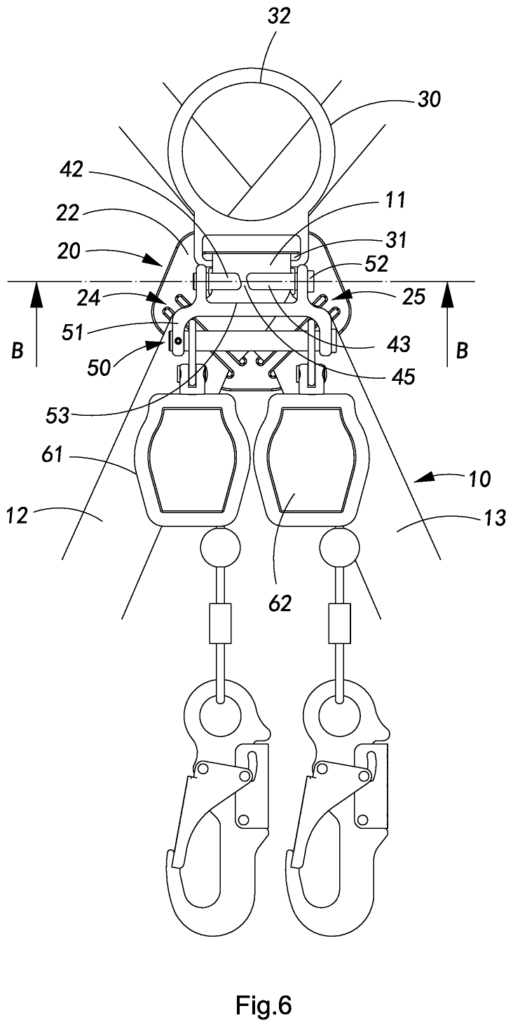

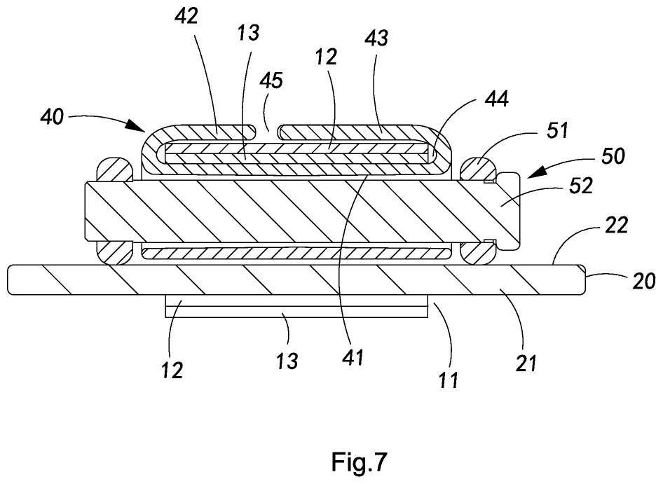

Referring to FIGS. 2-7, an anti-falling harness unit according to a preferred embodiment of the present invention is illustrated, wherein the harness unit comprises a safety wear 10, a support member 20, a lifting ring 30, a bushing 40, and a connecting device 50 adapted for coupling with the bushing 40.

The safety wear 10 is adapted for being worn by a personnel, wherein the safety wear 10 comprises a strap unit 11 on the back thereof. The safety wear 10 comprises a first strap 12 and a second strap 13 arranged with the first strap 12 in a cross manner.

The support member 20 has an inner side 21 adapted for leaning against the user and an outer side 22 opposite to the inner side 21. The support member 20 also has a first slot 23, a second slot 24 and a third slot 25, wherein the first slot 23 is a transverse through slot extending from the inner side 21 to the outer side 22 and each of the second slot 24. The second slot 24 and the third slot 25 are inclinedly arranged below the first slot 23 to form a triangular arrangement. The first strap 12 sequentially passes through the first slot 23 and the second slot 24, while the second strap 13 sequentially passes through the first slot 23 and the third slot 25. The first strap 12 and the second strap 13 pass through the first slot 23 in a piling or overlapping manner so as to define a securing region C between the strap unit 11 and the outer side 22 of the support member 20. The height of the securing region C is defined by a distance between a bottom of the first slot 23 and a top of the second slot 24. The second slot 24 has a pair of parallel first hole 241 and second hole 242 each extending from the inner side 21 to the outer side 22 of the support member 20. The first hole 241 and the second hole 242 allow the first strap 12 to sequentially pass through. The third slot 25 has a pair of parallel third hole 251 and fourth hole 252 each extending from the inner side 21 to the outer side 22 of the support member 20. The third hole 251 and the fourth hole 252 allow the second strap 13 to sequentially pass through.

The lifting ring 30 is arranged on the outer side 22 of the support member 20, wherein the lifting ring 30 has a strap groove 31, matching with the first slot 23 so as to allow both the first strap 12 and the second strap 13 orderly passing through the strap groove 31 and the first slot 23 in an overlapping manner, and has a lifting hole 32 arranged thereon above the strap groove 31 so as for being hung on a hanging spot in the air above the ground t (such as a beam or column of a building, a mounting ring, and etc.).

The bushing 40 adapted to be transversely arranged at the securing region C has a channel 41 axially formed therein for extending across the securing region C in a transverse direction of the securing region C. The bushing 40 further comprises a L-shaped first hook 42 extended from one end thereof and a L-shaped second hook 43 extended from the other end thereof so as to define and form a slideway 44 between an outer side of the bushing 40 and the first and second hooks 42, 43 for the first strap 12 and the second strap 13 to pass therethrough in an overlapping manner, such that when the bushing 42 bears stress, it can still correspondingly move up and down along the first strap 12 and the second strap 13 within the securing region C and without escaping from the left or right side of the securing region C accidently or informally. The bushing 40 also has a gap 45 defined between the free ends of the first and second hooks 42, 43 for the slideway 44, i.e. about a middle position of the slideway 44 for communicating the inside of the slideway 44 with outside , such that the bushing 40 is able to be detachably mounted on the strap unit 11. Further, the gap 45 is formed in a slant manner, so as to prevent the first strap 12 and the second strap 13 from escaping through the gap 45 easily.

The connecting device 50 comprises a frame 51 and a latch 52. The frame 51, between two ends thereof, provides and defines a hanging space 53 having an opening 54. The channel 41 of the bushing 40 is adapted to match within the opening 54. The first strap 12 and the second strap 13 pass through the hanging space 53 in a restricted manner. The latch 52 which passes through the channel 41 is installed between two ends of the frame 51 in an openable and closable manner, so as for the connecting device 50 to couple with two anti-falling devices 61 and 62 and to allow the two anti-falling devices 61 and 62 to alternately provide the user different auxiliary hanging points during transverse movement above the ground. Accordingly, when the user accidentally falls, the user is to be hung and supported by means of the anti-falling devices 61 and 62 equipping with the lifting ring 30 and the main hanging spot in the air above the ground in order to wait for rescue.

In view of above, the present invention has at least the following advantages.

First, the present invention allows the latch to quickly latch at the securing region directly, which avoids wasting time and efforts on pulling the strap unit and greatly enhances the adaption in mounting and dismounting of the connecting device.

Second, when the connecting device of the present invention bears walking or falling stresses, the bushing can comply with the stress to move up and down correspondingly within the securing region based on the slidable coupling arrangement between the slideway and the strap unit, so as to effectively mediate and buffer the stress bearing among the latch, the support member, and the strap unit, which greatly reduces the concentration of stress and therefore makes the overall structure and arrangement of the harness unit of the present invention more durable and secure.

To sum up, the overall structure and arrangement of the present invention is novel and advantageous, which is certainly a great creation of a technical construct and shall match the conditions of patent application. Therefore, it is applied herein in accordance with the law. However, what has been mentioned in the above preferred embodiment is only one of the workable embodiments of the present invention, which shall not be used to limit the scope of the practice of the present invention. In other words, all equivalent alternatives and modifications according to the claims of the present invention shall still be covered by the claimed scope of the present invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An anti-falling harness unit, comprising:
a safety wear, adapted for being worn by a personnel, wherein said safety wear comprises a lifting ring and a strap unit on a back thereof for mounting said lifting ring;
a support member, having an inner side adapted for leaning against the user, an outer side opposite to said inner side, a first slot, and a second slot provided below said first slot, wherein said first slot and said second slot are extended from said inner side to said outer side, wherein said strap unit is arranged to pass through said first slot and said second slot to define a securing region between said strap unit and said outer side of said support member, wherein a height of said securing region is defined by a distance between said first slot and said second slot;
a connecting device comprising a latch; and
a bushing, arranged at said securing region, having a channel axially provided therein and being adapted to position transversely across said securing region, wherein said bushing has a slideway to allow said bushing to correspondingly move up and down along said strap unit within said securing region and without escaping from a left or right side of said securing region wherein said channel is adaptable for said latch of said connecting device to couple with.

2. The anti-falling harness unit, as recited in claim 1, wherein said bushing further has a gap provided in a middle of said slideway for communicating said slideway with outside, such that said bushing is detachably mounted on said strap unit.

3. The anti-falling harness unit, as recited in claim 2, wherein said bushing further comprises a first hook and a second hook respectively extended from two ends thereof respectively to form and define said slideway, wherein said gap is located between said first hook and said second hook.

4. The anti-falling harness unit, as recited in claim 2, wherein said gap is formed in a slant manner.

5. The anti-falling harness unit, as recited in claim 3, wherein said gap is formed in a slant manner.

6. The anti-falling harness unit, as recited in claim 1, wherein said connecting device further comprises a frame, wherein a hanging space, having an opening, is defined between two ends of said frame, wherein said channel of said brushing is adapted to match within said opening, wherein said first strap and said second strap pass through said hanging space in a restricted manner, wherein said latch passes through said channel to be mounted on the two ends of said frame in an openable and closable manner, so as for said connecting device to couple with at least one anti-falling device.

7. The anti-falling harness unit, as recited in claim 2, wherein said connecting device further comprises a frame, wherein a hanging space, having an opening, is defined between two ends of said frame, wherein said channel of said brushing is adapted to match within said opening, wherein said first strap and said second strap pass through said hanging space in a restricted manner, wherein said latch passes through said channel to be mounted on the two ends of said frame in an openable and closable manner, so as for said connecting device to couple with at least one anti-falling device.

8. The anti-falling harness unit, as recited in claim 3, wherein said connecting device further comprises a frame, wherein a hanging space, having an opening, is defined between two ends of said frame, wherein said channel of said brushing is adapted to match within said opening, wherein said first strap and said second strap pass through said hanging space in a restricted manner, wherein said latch passes through said channel to be mounted on the two ends of said frame in an openable and closable manner, so as for said connecting device to couple with at least one anti-falling device.

9. The anti-falling harness unit, as recited in claim 1, further comprising a lifting ring, which has a strap groove for said strap unit to pass through and a lifting hole formed therein, wherein said strap unit comprises a first strap and a second strap arranged with said first strap in a cross manner, wherein said lifting ring is arranged on said outer side of said support member.

10. The anti-falling harness unit, as recited in claim 2, further comprising a lifting ring, which has a strap groove for said strap unit to pass through and a lifting hole formed therein, wherein said strap unit comprises a first strap and a second strap arranged with said first strap in a cross manner, wherein said lifting ring is arranged on said outer side of said support member.

11. The anti-falling harness unit, as recited in claim 3, further comprising a lifting ring, which has a strap groove for said strap unit to pass through and a lifting hole formed therein, wherein said strap unit comprises a first strap and a second strap arranged with said first strap in a cross manner, wherein said lifting ring is arranged on said outer side of said support member.

12. The anti-falling harness unit, as recited in claim 9, wherein said support member further has a third slot provided below said first slot and inclinedly with said second slot, wherein said first strap sequentially passes through said first slot and said second slot, wherein said second strap sequentially passes through said first slot and said third slot, wherein said first strap and said second strap pass through said first slot in an overlapping manner, wherein a height of said securing region is defined by a distance between a bottom of said first slot and a top of said second slot.

13. The anti-falling harness unit, as recited in claim 12, wherein said first slot is extended from said inner side to said outer side of said support member, wherein said second slot has a pair of parallel first hole and second hole each extending said inner side to said outer side of said support member, wherein said first hole and said second hole are adapted for said first strap to sequentially pass therethrough, wherein said third slot has a pair of parallel third hole and fourth hole each extending from said inner side to said outer side of said support member, wherein said third hole and said fourth hole are adapted for said second strap to sequentially pass therethrough.

14. The anti-falling harness unit, as recited in claim 12, wherein said connecting device further comprises a frame which has a hanging space, having an opening, defined between two ends thereof, wherein said channel of said bushing is adapted to match within said opening, wherein said first strap and said second strap pass through said hanging space in a restricted manner, wherein said latch passes through said channel to be mounted on the two ends of said frame in an openable and closable manner, so as for said connecting device to couple with at least one anti-falling device.

15. The anti-falling harness unit, as recited in claim 10, wherein said support member further has a third slot provided below said first slot and inclinedly with said second slot, wherein said first strap sequentially passes through said first slot and said second slot, wherein said second strap sequentially passes through said first slot and said third slot, wherein said first strap and said second strap pass through said first slot in an overlapping manner, wherein a height of said securing region is defined by a distance between a bottom of said first slot and a top of said second slot.

16. The anti-falling harness unit, as recited in claim 15, wherein said first slot is extended from said inner side to said outer side of said support member, wherein said second slot has a pair of parallel first hole and second hole each extending said inner side to said outer side of said support member, wherein said first hole and said second hole are adapted for said first strap to sequentially pass therethrough, wherein said third slot has a pair of parallel third hole and fourth hole each extending from said inner side to said outer side of said support member, wherein said third hole and said fourth hole are adapted for said second strap to sequentially pass therethrough.

17. The anti-falling harness unit, as recited in claim 15, wherein said connecting device further comprises a frame which has a hanging space, having an opening, defined between two ends thereof, wherein said channel of said bushing is adapted to match within said opening, wherein said first strap and said second strap pass through said hanging space in a restricted manner, wherein said latch passes through said channel to be mounted on the two ends of said frame in an openable and closable manner, so as for said connecting device to couple with at least one anti-falling device.

18. The anti-falling harness unit, as recited in claim 11, wherein said support member further has a third slot provided below said first slot and inclinedly with said second slot, wherein said first strap sequentially passes through said first slot and said second slot, wherein said second strap sequentially passes through said first slot and said third slot, wherein said first strap and said second strap pass through said first slot in an overlapping manner, wherein a height of said securing region is defined by a distance between a bottom of said first slot and a top of said second slot.

19. The anti-falling harness unit, as recited in claim 18, wherein said first slot is extended from said inner side to said outer side of said support member, wherein said second slot has a pair of parallel first hole and second hole each extending said inner side to said outer side of said support member, wherein said first hole and said second hole are adapted for said first strap to sequentially pass therethrough, wherein said third slot has a pair of parallel third hole and fourth hole each extending from said inner side to said outer side of said support member, wherein said third hole and said fourth hole are adapted for said second strap to sequentially pass therethrough.

20. The anti-falling harness unit, as recited in claim 18, wherein said connecting device further comprises a frame which has a hanging space, having an opening, defined between two ends thereof, wherein said channel of said bushing is adapted to match within said opening, wherein said first strap and said second strap pass through said hanging space in a restricted manner, wherein said latch passes through said channel to be mounted on the two ends of said frame in an openable and closable manner, so as for said connecting device to couple with at least one anti-falling device.
